(19) United States
(12) Patent Application Publication
(10) Pub. No.: US 2025/0276322 A1
(43) Pub. Date: Sep. 4, 2025

(54) FLOUR MILLING DEVICE AND METHOD THEREOF

(71) Applicant: HCL Technologies Limited, New Delhi (IN)

(72) Inventors: Shatakshii Shukla, Bangalore (IN); Abhijith Padinjarekkarahari Narayanan, Bangalore (IN); Sajayesh Vijayachandran, Bangalore (IN); Sanjay Stalin, Bangalore (IN)

(21) Appl. No.: 18/967,779

(22) Filed: Dec. 4, 2024

(30) Foreign Application Priority Data
Feb. 29, 2024 (IN) 202411015185

(51) Int. Cl. B02C 4/16; B02C 4/28; B02C 25/00

(52) U.S. Cl. CPC B02C 4/16; B02C 4/06; B02C 4/286; B02C 4/32; B02C 4/34; B02C 25/00

(57) ABSTRACT

This disclosure relates to a flour milling device. The flour milling device includes a hopper including Near Infrared (NIRED) sensors configured for identifying a type of grains fed into the hopper to provide at least one grinding option to a user. The flour milling device further includes a pair of anodized aluminum rollers positioned below the hopper and horizontally aligned with each other. A first anodized aluminum roller is stationary, and a second anodized aluminum roller is configured to move to adjust spacing based on a selected grinding option. The flour milling device further includes a corundum stone and a corundum roller positioned below the pair of anodized aluminum rollers. The corundum stone is stationary, and the corundum roller is configured to move to adjust spacing based on the selected grinding option. The flour milling device further includes an inbuilt cleaning mechanism to automatically clean the flour milling device.

### TECHNICAL FIELD

This disclosure relates generally to the field of grinding, and more particularly to a flour milling device and method thereof.

### BACKGROUND

In today's fast-paced world, many people rely on pre-packaged grains and pulses flour for cooking their daily dishes. These packaged flours that are produced on a large scale using industrial milling machines often lack natural flavor and nutritional content. To address this issue, some people opt for outdoor grains milling, while others resort to home grinding methods such as traditional manual stone mills, as an alternative to packaged flours that are commercially produced. However, the above approaches of milling grains outside or using the traditional manual stone mills have certain drawback such as dependency on manual labor, rudimentary machinery, and time-consumption thereby leading to inefficient end product production with compromised quality.

Further, while these approaches serve their purposes, they often lack the versatility required for efficient, hygienic, and sustainable flour production across different scales. In addition, the above-mentioned approaches that use traditional flour milling devices often suffer from inefficiencies, inconsistent output, and excessive energy consumption. To address the issues of the above-mentioned approaches, home flour milling devices have emerged as popular tools for people that are eager to take control of their flour production. These modern home flour milling devices provide users the convenience of milling various grains at home, allowing the users to enjoy the benefits of freshly grounded flour. However, these modern home flour milling devices have addressed some of these issues but have their own set of drawbacks as they often sacrifice the nuanced control over the traditional milling approaches that is crucial for achieving specific flour characteristics. Further, these existing modern home flour milling devices often lack the adaptability to process different grains optimally. Moreover, the milling process and technology used by these modern home flour milling devices leads to loss of certain nutrients due to excessive heat generation. Additionally, these existing modern home flour milling devices are often bulky, and non-convenient, require multiple feedings to achieve a fine powder, and pose challenges in terms of user interaction and cleaning.

Hence, there remains a need for a comprehensive milling device that combines the best aspects of traditional as well as modern milling techniques, offering a user-friendly interface, energy efficiency, and an ability to produce customized flour grades. Therefore, there is a need in the present state of art of an innovative flour milling device.

### SUMMARY

In one embodiment, a flour milling device is disclosed. In one example, the flour milling device includes a hopper, a pair of anodized aluminum rollers, a corundum stone and a corundum roller, and an inbuilt cleaning mechanism. The hopper further includes a set of Near Infrared (NIRED) sensors that are configured to identify a type of grains fed into the hopper to provide at least one grinding option as a recommendation to a user. Further, the pair of anodized aluminum rollers are positioned below the hopper and are horizontally aligned with each other. A first anodized aluminum roller is stationary, and a second anodized aluminum roller is configured to move for a first pre-defined distance in a horizontal direction to automatically adjust a spacing between the first anodized aluminum roller and the second anodized aluminum roller based on a grinding option selected from the at least one grinding option. Further, the corundum stone and the corundum roller are positioned below the pair of anodized aluminum rollers and are horizontally aligned with each other. The corundum stone is stationary, and the corundum roller is configured to move for a second pre-defined distance in a horizontal direction to automatically adjust a spacing between the corundum stone and the corundum roller based on the grinding option. Further, the inbuilt cleaning mechanism includes a set of steel brushes and a pair of blowers that are configured to automatically clean the flour milling device. Each of the pair of blowers includes a set of fans.

In another embodiment, a method for milling grains through a flour milling device is disclosed. In one example, the method includes identifying a type of grains fed into a hopper via a set of Near-Infrared (NIRED) sensors. The hopper includes the set of NIRED sensors. The method further includes generating at least one grinding option for milling of the grains based on the identification of the type of the grains. The method includes receiving a user selection corresponding to a grinding option from the at least one grinding option. In response to receiving the user selection for the grinding option, the method includes adjusting position of a second anodized aluminum roller from a pair of anodized aluminum rollers positioned below the hopper, based on the grinding option and adjusting position of a corundum roller positioned below the pair of anodized aluminum rollers based on the grinding option. The method further includes milling the grains based on the grinding option, upon adjusting the position of the second anodized aluminum roller and the corundum roller.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1A illustrates an exemplary flour milling device, in accordance with some embodiments of the present disclosure.

FIG. 1B illustrates a top view of a flour milling device, in accordance with some embodiments of the present disclosure.

FIG. 1C illustrates a cross-sectional view of a flour milling device, in accordance with some embodiments of the present disclosure.

FIG. 2 illustrates an exemplary communication system of a flour milling device, in accordance with some embodiments of the present disclosure.

FIG. 3 illustrates a working mechanism of a flour milling device, in accordance with some embodiments of the present disclosure.

FIGS. 4A and 4B represent an exemplary inbuilt cleaning mechanism of a flour milling device, in accordance with some embodiments of the present disclosure.

FIG. 5 is a pictorial depiction of an exemplary process of operating a flour milling device, in accordance with some embodiments of the present disclosure.

FIG. 6 illustrates a flowchart of a method of milling grains through a flour milling device, in accordance with some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

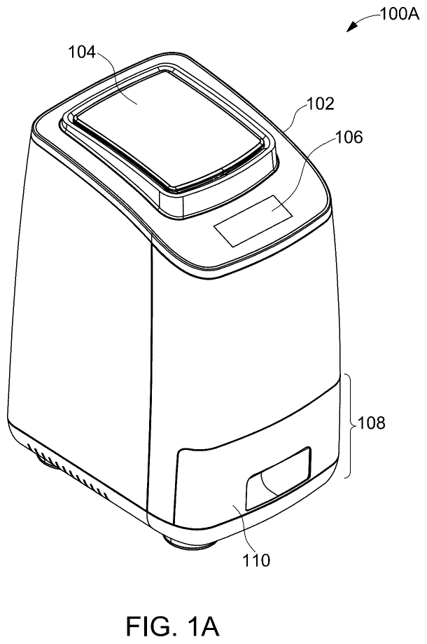

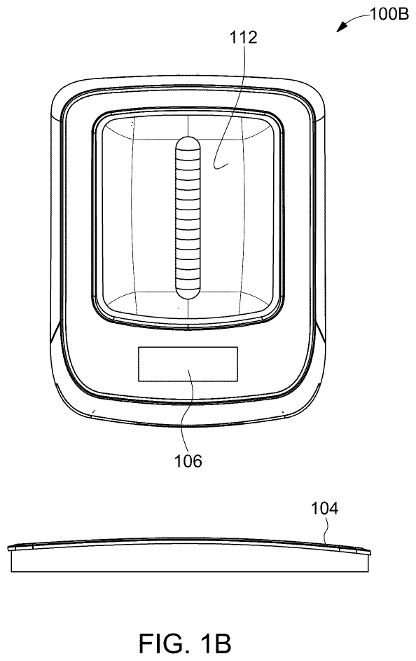

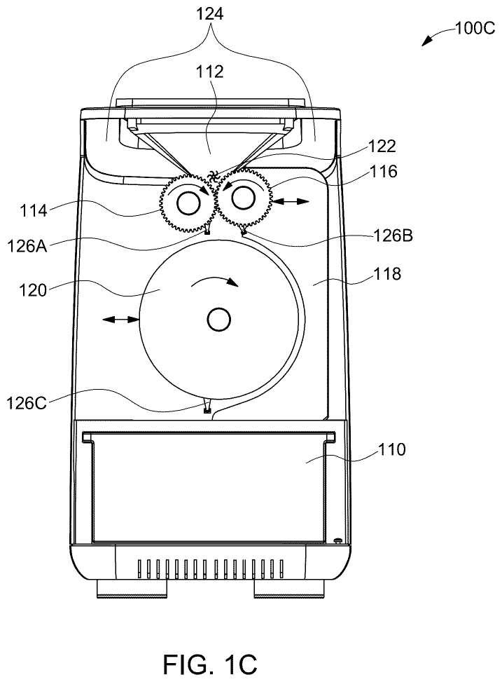

Referring now to FIG. 1A, an exemplary flour milling device 100A is illustrated, in accordance with some embodiments of the present disclosure. The flour milling device 100A may be configured to perform milling of grains based on user requirements. In other words, the flour milling device 100A may be configured to mill the grains based on user desired milling preferences. In order to perform milling of the grains, in some embodiments, the flour milling device 100A may include a controller (not shown) (for example, server, processor(s), microcontroller, Computer Processing Unit (CPU), or any other computing device). The controller may be configured to operate the flour milling device 100A based on a grinding option selected by a user for milling grains using the flour milling device 100A. Examples of different types of grains that can be milled using the flour milling device 100A may be, but not limited to, wheat, cereal, pulses, rice, oats, or any other edible grains.

As depicted via the present FIG. 1A, the flour milling device 100A may be a compact and space saving device. In other words, the flour milling device 100A may be designed to seamlessly fit into a modern kitchen taking up a minimal space. The depicted flour milling device 100A may be powerful regardless of its compact design, offering perfect balance between functionality and user convenience. Further, as depicted via FIG. 1A, a top 102 of the flour milling device 100A may include a lid 104, and a communication system 106. The lid 104 may be detachably attached to the flour milling device 100A. In other words, the lid 104 may be removed by the user as and when required by the user. The user may remove the lid 104 to access a hopper for adding the grains to the hopper. This is further depicted and explained in FIG. 1B. The lid 104 may be configured to cover the hopper so that no outside particles (e.g., dust particles) or impurity gets into the flour milling device 100A during grains milling process.

Further, the communication system 106 may include an interactive display to display messages to the user. The communication system 106 may further include a set of buttons for operating the flour milling device 100A. In addition, the communication system 106 may include a communication module for sending the messages to a user device and receiving commands from the user via the user device. In other words, in some embodiments, the user may interact with the flour milling device via the user device to operate the flour milling device 100A. Examples of the user device may include a smartphone, a tablet, a laptop, a notebook, a desktop, and the like. Further, the flour milling device 100A may send the messages to the user device and receive the commands from the user device over a communication network. The communication network, for example, may be any a wireless communication network and the examples may include, but are not limited to, the Internet, Wireless Local Area Network (WLAN), Wi-Fi, Worldwide Interoperability for Microwave Access (WiMAX), and General Packet Radio Service (GPRS).

Further, a bottom 108 of the flour milling device 100A may include a removable collector vessel 110. The removable collector vessel 110 may collect the milled grains during the grains milling process. In other words, when the grains milling process is in progress, then the removable collector vessel 110 may be configured to collect the milled grains. And, once the grains milling process is over, then the user may remove the removable collector vessel 110 from the bottom 108 to transfer the milled grains into a container. It should be noted that the bottom 108 may include a motor (not shown). The motor may be configured to operate the flour milling device 100A. As will be appreciated, the motor may operate the flour milling device 100A upon receiving instructions from the controller via the communication system 106. In addition, the bottom 108 may include a set of shock absorbent bushes. The set of shock absorbent bushes may be configured to stabilize movement of the flour milling device 100A. In other words, the set of shock absorbent bushes may restrict movement of the flour milling device 100A while the grains milling process is in progress.

Referring now to FIG. 1B, a top view 1001B of the flour milling device 100A is illustrated, in accordance with some embodiments of the present disclosure. FIG. 1B is explained in conjunction with FIG. 1A. As depicted via the present FIG. 1B, the user of the flour milling device 100A may remove the lid 104 to access a hopper 112. Upon removing the lid 104, the user may add the grains to be milled to the hopper 112. The hopper 112 may be configured to store the grains for the grains milling process. Further, the hopper 112 may include a set of Near Infrared (NIRED) sensors (not shown). The set of NIRED sensors may be configured for identifying a type of grains that is fed into the hopper 112. The type of grains may be identified to provide at least one grinding option as a recommendation to the user. Examples of the type of grains may include, but are not limited to, wheat, cereal, pulses, rice, oats, or any other edible grains. As will be appreciated, a NIRED sensor may use near infrared lights and employ spectral analysis techniques to identify the types of grains. In other words, the NIRED sensor may emit near infrared lights and receive reflected light or light patterns to determine size, features, etc. to identify the type of grains fed into the hopper 112. In addition to the NIRED sensors, the flour milling device 100A may include an Artificial Intelligence (AI) model and a database for identifying the type of grains fed into the hopper 112.

Upon identifying the type of grains, at least one grinding option may be provided as a recommendation to the user. In other words, upon identifying the type of grains, the at least one grinding option may be displayed to the user via the interactive display of the communication system 106 or via a display of the user device. The at least one grinding option may include, but is not limited to, a rolled grains option, a half-broken grains option, a one-fourth broken grains option, a coarse powder option, and a fine powder option. Further, in an embodiment, once the grains are added to the hopper 112, then the hopper 112 may be covered by the lid 104. Further, the lid 104 may secure the grains within the hopper 112 for any impurities and avoid spilling of the grains during the grains milling process. In other words, the lid 104 may make sure that no outside particles or impurities get into the hopper 112 of the flour milling device 100A during the grains milling process.

Referring now to FIG. 1C, a cross-sectional view 100C of the flour milling device 100A is illustrated, in accordance with some embodiments of the present disclosure. FIG. 1C is explained in conjunction with FIGS. 1A and 1B. It should be noted that the cross-sectional view 100C is a back view of the flour milling device 100A. As already explained in FIG. 1A, the flour milling device 100A may be smart, compact, and efficient home milling device that is configured to mill the grains in a home environment to provide convenience to the user. Additionally, the flour milling device 100A may be designed in a way such that natural goodness of the grains is maintained even after milling.

Further, as depicted via the cross-sectional view 1000, the flour milling device 100A may include the hopper 112, a pair of anodized aluminum rollers, i.e., a first anodized aluminum roller 114 and a second anodized aluminum roller 116, a corundum stone 118 and a corundum roller 120, and an inbuilt cleaning mechanism (not shown). It should be noted that the first anodized aluminum roller 114 and the second anodized aluminum roller 116 may be collectively referred as the pair of anodized aluminum rollers 114, 116. The hopper 112 may be configured to store the grains for the grains milling process as already explained in detail in FIGS. 1A and 1B. Further, the hopper 112 of the flour milling device 100A may include the set of the NIRED sensors. The set of NIRED sensors may be configured for identifying the type of grains fed into the hopper 112. In an embodiment, the set of NIRED sensors may identify the type of grains to provide the at least one grinding option as the recommendation to the user. Examples of the type of grains may include, but are not limited to, wheat, cereal, pulses, rice, oats, or any other edible grains. The at least one grinding option may include, but is not limited to, a rolled grains option, a half-broken grains option, a one-fourth broken grains option, a coarse powder option, and a fine powder option.

The hopper 112 of the flour milling device 100A may be accessible by removing the lid 104 present on the top 102 of the flour milling device 100A, as depicted via FIGS. 1A and 1B. The user of the flour milling device 100A may remove the lid 104 for adding the grains to the hopper 112. As depicted via the cross-sectional view 100C, the pair of anodized aluminum rollers 114, 116 of the flour milling device 100A may be positioned below the hopper 112. Further, each of the pair of anodized aluminum rollers 114, 116 may be horizontally aligned with each other. The first anodized aluminum roller 114 may be configured to remain stationary. Further, the second anodized aluminum roller 116 may be configured to move for a first pre-defined distance in a horizontal direction as depicted via a double ended arrow. The second anodized aluminum roller 116 may be configured to move for the first pre-defined distance to automatically adjust a spacing between the first anodized aluminum roller 114 and the second anodized aluminum roller 116 based on a grinding option selected from the at least one grinding option.

In other words, the first anodized aluminum roller 114 may be configured to rotate in a clockwise direction and remains stationary at its place. While the second anodized aluminum roller 116 may be configured to rotate in an anticlockwise direction and moves towards or away from the first anodized aluminum roller 114 for the first pre-defined distance. In an embodiment, the first pre-defined distance for which the second anodized aluminum roller 116 is movable may be defined for each of the at least one grinding option. By way of an example, for the one-fourth broken grains option, the second pre-defined distance for the second anodized aluminum roller 116 may be defined, e.g., 5 millimeters (mm). Similarly, for the rolled grains option, the second pre-defined distance for may be defined, e.g., 2.5 mm.

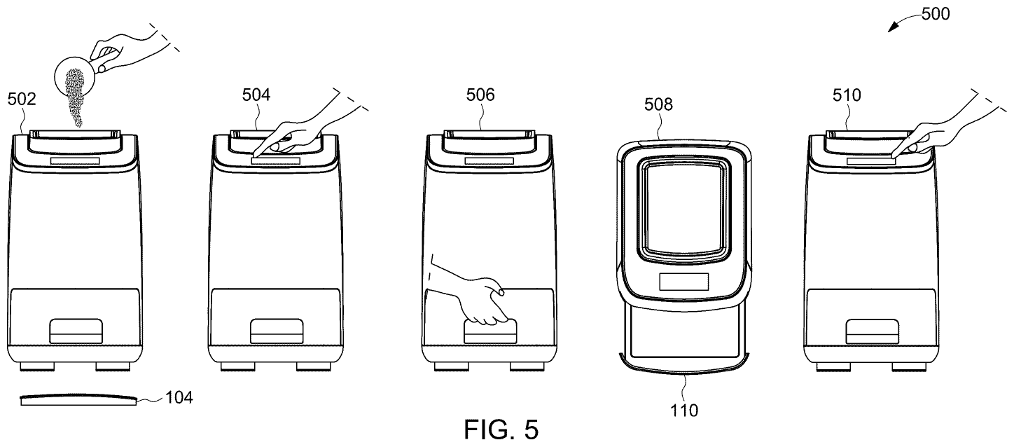

Further, once the spacing between the pair of anodized aluminum rollers 114, 116 is adjusted, then during the grains milling process, the first anodized aluminum roller 114 may be configured to rotate in the clockwise direction as depicted via a single endpoint arrow. Whereas the second anodized aluminum roller 116 may be configured to rotate in the anti-clockwise direction as depicted via a single endpoint arrow. It should be noted that, an endpoint of the single endpoint arrow depicts the direction of rotation of the first anodized aluminum roller 114 and the second anodized aluminum roller 116. In an embodiment, the second anodized aluminum roller 116 may move for the first pre-defined distance in the horizontal direction via a set of actuators (not shown). This is explained further in detail in conjunction with FIG. 5.

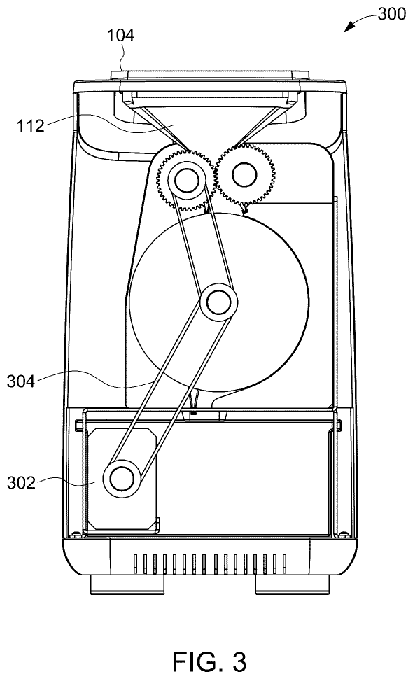

Further, as depicted via the cross-sectional view 1000, the corundum stone 118 and the corundum roller 120 may be positioned below the pair of anodized aluminum rollers 114, 116. The corundum stone 118 and the corundum roller 120 may be horizontally aligned with each other. In an embodiment, the corundum stone 118 may be a concave faced corundum stone. As depicted via the cross-sectional view 1000, the corundum stone 118 may be positioned below the second anodized aluminum roller 116 on one of a side of the flour milling device 100A. The corundum stone 118 may be configured to remain stationary. Further, the corundum roller 120 may be configured to move for a second pre-defined distance in a horizontal direction as depicted via a double ended arrow. The corundum roller 120 may be movable to the second pre-defined distance to automatically adjust a spacing between the corundum stone 118 and the corundum roller 120 based on the selected grinding option. In other words, the corundum roller 120 may be configured to move towards or away in correspondence to a concave face of the corundum stone 118 to adjust the spacing based on the selected grinding option. In an embodiment, the second pre-defined distance for which the corundum roller 120 is movable may be defined for each of the at least one grinding option. By way of an example, for the one-fourth broken grains option, the second pre-defined distance for the corundum roller 120 may be defined, e.g., 2 mm. Similarly, for the rolled grains option, the second pre-defined distance for the corundum roller 120 may be defined, e.g., 5 mm. Further, the corundum roller 120 may move for the second pre-defined distance in the horizontal direction to adjust the spacing via the set of actuators. In an embodiment, the corundum roller 120 may be configured to rotate in the clockwise direction as depicted via a single endpoint arrow, during the grains milling process. This is further depicted and explained in greater detail in conjunction with FIG. 3. It should be noted that, this unique combination and arrangement of the pair of anodized aluminum rollers 114, 116, and the corundum stone 118 and the corundum roller 120 may provide a precision milling mechanism that guarantees uniform texture of the milled flour. Moreover, the precision milling mechanism may minimize heat generation during the grains milling process hence avoid compromise in nutritional value of the milled flour. Additionally, the flour milling device 100A may include an intake roller 122. The intake roller 122 may be configured to dispense an appropriate amount of grains that are fed into the hopper 112. As depicted via the cross-sectional view 100C, the intake roller 122 may be inline with the hopper 112 and have a unique shape that helps regulate dispensing speed of the grains. It should be noted that the intake roller 122 may be configured to adjust its speed based on the type of grains selected by the user.

Further, the inbuilt cleaning mechanism of the flour milling device 100A may be configured to automatically clean the flour milling device 100A after the grains milling process. In other words, once the grains milling process is complete and the milled grains (i.e., flour) collected within the removable collector vessel 110 is transferred to the container, then the inbuilt cleaning mechanism may be started to automatically clean the flour milling device 100A. To start the inbuilt cleaning mechanism, the user may click or press a button from the set of buttons to start the inbuilt cleaning mechanism. In some embodiments, the user may start the inbuilt cleaning mechanism by selecting a suitable option (e.g., a cleaning option) rendered to the user via a milling application installed within the user device. The inbuilt cleaning mechanism may include a set of steel brushes (for example: a first steel brush 126A, a second steel brush 126B, and a third steel brush 126C) and a pair of blowers 124 configured to automatically clean the flour milling device 100A. Each of the pair of blowers 124 may include a set of fans (not shown). Further, a brush of the set of steel brushes may be positioned in contact with a circumference of each of the first anodized aluminum roller 114, the second anodized aluminum roller 116, and the corundum roller 120. For example, suppose the set of steel brushes may include three steel brushes. Further, the first steel brush 126A and the second steel brush 126B of the set of steel brushes may be positioned in contact with the circumference of the first anodized aluminum roller 114 and the second anodized aluminum roller 116 respectively, as depicted via the present FIG. 1C. In addition, the third steel brush 126C may be positioned in contact with the circumference of the corundum roller 120.

Further, the pair of blowers 124 may be positioned below the hopper 112 and in-line with the first anodized aluminum roller 114, the second anodized aluminum roller 116, and the corundum roller 120. When the user starts the inbuilt cleaning mechanism by selecting the cleaning option, the first anodized aluminum roller 114, the second anodized aluminum roller 116, and the corundum roller 120 may start rotating. Further, each of the set of steel brushes that touches the circumference may remove any sticky grains particles (or remains) left on the circumference of the first anodized aluminum roller 114, the second anodized aluminum roller 116, and the corundum roller 120 during their rotation. In addition, air flow from the pair of blowers 124 may blow the remains that gets collected into the removable collector vessel 110 placed at the bottom 108 of the flour milling device 100A. Once the inbuilt cleaning mechanism is over or stops then the user may remove the removable collector vessel 110 for cleaning.

Further, as explained in FIG. 1A, the flour milling device 100A may include the motor and the set of shock absorbent bushes. The motor may be configured to operate the flour milling device 100A by rotating the pair of anodized aluminum roller 114, 116, and the corundum roller 120 during the grains milling process. A working mechanism of the flour milling device 100A is further explained in detail in conjunction with FIG. 3. It should be noted that, speed of each of the pair of anodized aluminum rollers 114, 116, and the corundum roller 120 may be automatically adjusted based on the grinding option selected corresponding to the grains fed into the hopper. The set of shock absorbent bushes may be configured to stabilize movement of the flour milling device 100A.

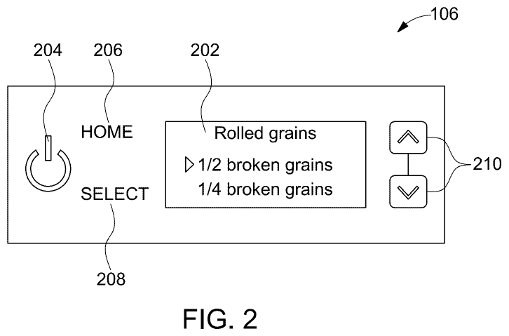

Referring now to FIG. 2, an exemplary communication system of the flour milling device 100A is illustrated, in accordance with some embodiments of the present disclosure. FIG. 2 is explained in conjunction with FIGS. 1A-1C. The exemplary communication system may be analogous to the communication system 106 of the flour milling device 100A. In an embodiment, the communication system 106 may include an interactive display 202, the set of buttons, and the communication module.

The communication system 106 may be used by the user to operate the flour milling device 100A based on his requirement. The interactive display 202 may be configured to display messages to the user. The messages may include the at least one grinding option, a grain volume option, a progress in the grains milling process, a notification of completion of the grains milling process, and a notification of completion of cleaning process. Further, the at least one grinding option may include the rolled grains option, the half-broken grains option, the one-fourth broken grains option, the coarse powder option, and the fine powder option. By way of an example, upon identifying the type of grains (e.g., oats), the interactive display 202 may display a grinding option (e.g., a coarse powder option) to the user, upon identifying the type of grains fed into the hopper 112. It should be noted that for ease of explanation displaying of one grinding option, i.e., the coarse powder option is considered. However, more than one grinding option (e.g., the coarse powder option, and the fine powder option) may be displayed to the user based on the identification of the type of grains (oats in this case), via the interactive display 202. Further, the user may select a volume option from one or more grains volume options rendered to the user via the interactive display 202 based on volume of grains fed into the hopper 112. In some embodiments, volume measuring sensors (e.g., ultrasonic sensors, laser displacement sensors, etc.) may be integrated within the hopper 112 to determine volume of the grains fed into the hopper 112.

Further, the progress in the grains milling process displayed via the interactive display 202 may include real-time status (current progress status, e.g., 20%, 40%, or complete status, e.g., 100%) of milling of the grains. Further, the notification of completion of the grains milling process displayed via the interactive display 202 may include a notification, e.g., ‘grains milling process complete’ corresponding to the completion of the grain milling process. In addition, the notification of completion of the cleaning process displayed via the interactive display 202 may include a notification, e.g., ‘device cleaning process complete’ that is displayed once the cleaning of the flour milling device 100A is completed using the inbuilt cleaning mechanism. In some embodiments, each of the messages may be transmitted and rendered to the user on the display of the user device (e.g., smartphone). It should be noted that the messages may be transmitted by the communication module of the communication system 106 over the communication network to the smartphone of the user. Further, the user may interact with the flour milling device 100A via the milling application installed within his smartphone.

Further, the set of buttons of the communication system 106 may be configured to operate the flour milling device 100A, select the grinding option, start the cleaning mechanism, etc. In other words, the user may use the set of buttons to perform one or more actions that includes operating the flour milling device 100A, selecting the grinding option, and the like. As depicted via the present FIG. 2, the set of buttons may include a power button 204, a home button 206, a select button 208, and a pair of navigation buttons 210. The power button 204 may be used by the user to perform ‘on’ and ‘off’ operation for the flour milling device 100A. In other words, the power button 204 may be used by the user to turn ‘on’ or ‘off’ the flour milling device 100A. Further, the home button 206 may be used by the user to go back to a start screen (or a home screen).

Further, the select button 208 may be used by the user to select various options, such as ‘start milling process option’ or ‘start cleaning process option’ displayed to the user on the start screen. Furthermore, the select button 208 may be used by the user to select the suitable grinding option from one or more grinding options rendered to the user via the interactive display 202. In addition, the pair of navigation buttons 210 may be used by the user to scroll through the one or more grinding options rendered to the user via the interactive display 202. In some embodiments, the pair of navigation buttons 210 may be used to select a suitable grains volume option from the one or more grains volume options rendered to the user.

By way of an example, suppose a user feeds the hopper 112 of the flour milling device 100A with wheat grains. Further, the user may want to grind the wheat grains in one-fourth broken grains. For this, initially, the user may turn on the flour milling device 100A by pressing the power button 204. The user may use the select button 208 to select ‘the start the milling process option’. Further, the user may then navigate to the one-fourth broken grain option from the one or more grinding options rendered to the user using the pair of navigation buttons 210. Further, the user may select the one-fourth grains broken option using the select button 208. The flour milling device 100A may then perform the grains milling process and the one-fourth broken grains (i.e., the one-fourth broken wheat grains) get collected in the removable collector vessel 110. Once the grains milling process is complete, the user may transfer the one-fourth broken wheat grains to a storage container for future use. The user may then initiate the cleaning process by pressing the home button 206 and selecting ‘the start cleaning process option’ using the select button 208.

In an embodiment, the communication module may be configured for sending the messages to the user device and receiving commands from the user corresponding to the selected grinding size option, starting the grains milling process, and starting the cleaning process, via the user device. As explained above, the user may interact with the flour milling device 100A via the milling application installed within the user device. Further, the user device may interact with the communication module over the communication network. Examples of the user device may include, but are not limited to, a smartphone, a tablet, a laptop, a notebook, a desktop, and the like. In other words, the user may operate the flour milling device 100A remotely using the user device. By way of an example, let's say the user for any reason is not near the flour milling device 100A but wants to grind pre-loaded grains in the hopper 112. In such cases, the user may operate the flour milling device 100A to perform the grains grinding process via the milling application installed in his smartphone. Further, using the milling application, the user may start the cleaning process for the flour milling device 100A.

Referring now to FIG. 3, a working mechanism 300 of the flour milling device 100A is illustrated, in accordance with some embodiments of the present disclosure. FIG. 3 is explained in conjunction with FIGS. 1A-2. With reference to FIG. 1A-1C, the flour milling device 100A may include the hopper 112 that is covered using the lid 104. The user may access the hopper 112 by removing the lid 104. Upon removing the lid 104, the user may feed grains (e.g., rice grains) that need to be milled into the hopper 112. Once the grains are fed into the hopper 112, then the user may cover the hopper 112 using the lid 104. The lid 104 may be configured to avoid spilling of the grains or restrict outside particles or impurities from entering the hopper 112 during the grain milling process so as to keep the gain milling process completely hygienic. As depicted via present FIG. 3, the hopper 112 may be in a conical shape including a broad opening for feeding the grains into the hopper 112 and a narrow opening for dispensing the grains during the grains milling process. It should be noted that the narrow opening may control flow of the grains from the hopper 112 into the pair of anodized aluminum rollers 114, 116.

Once the grains are fed into the hopper 112, the set of NIRED sensors integrated within the hopper 112 may identify the type of grains fed into the hopper 112. Further, upon identifying the types of grains, the at least one grinding option may be rendered as the recommendation to the user. The at least one grinding option may include the rolled grains option, the half-broken grains option, the one-fourth broken grains option, the coarse powder option, and the fine powder option.

Further, the at least one grinding option may be rendered to the user via the interactive display 202 of the flour milling device 100A or via the display of the user device. The user may select a grinding option from the at least one grinding option using the set of buttons or via the milling application. In an exemplary embodiment, if the type of grains identified and the at least one grinding option rendered to the user is not correct, then the user may manually enter the type of grains and accordingly select a suitable grinding option using the interactive display 202 and the set of buttons of the communication system 106. Examples of the interactive display 202 may be, but not limited to, a touchscreen, a keypad enabled screen, a voice recognition enabled screen, etc. In some embodiments, the user may manually enter the type of grains and accordingly select the suitable grinding option via the milling application installed in the user device.

Further, based on the selected grinding option, the spacing between the pair of anodized aluminum rollers 114, 116 may be automatically adjusted. Similarly, based on the selected grinding option, the spacing between the corundum stone 118 and the corundum roller 120 may be automatically adjusted. As already explained in FIG. 1C, the pair of anodized aluminum rollers 114, 116, may be positioned below the hopper 112, and the corundum stone 118 and the corundum roller 120 is positioned below the pair of anodized aluminum rollers 114, 116. Further, the spacing between the first anodized aluminum roller 114 and the second anodized aluminum roller 116 may be adjusted by moving the second anodized aluminum roller 116 to the first pre-defined distance in the horizontal direction. Similarly, the spacing between the corundum stone 118 and the corundum roller 120 may be adjusted by moving the corundum roller 120 for the second pre-defined distance in the horizontal direction. The spacing may be adjusted via the set of actuators.

Further, during the grains milling process, the first anodized aluminum roller 114 may be configured rotate in the clockwise direction, while the second anodized aluminum roller 116 may rotate in the anti-clockwise direction based on torque generated by a motor 302. In addition, the corundum stone 118 may be stationary at its place, while the corundum roller 120 may rotate in the clockwise direction based on the torque generated by the motor 302. In addition to the spacing, the speed of each of the pair of anodized aluminum rollers 114, 116, and the corundum roller 120 may be automatically adjusted based on the grinding option selected corresponding to the grains. As depicted via the present FIG. 3, the pair of anodized aluminum rollers 114, 116, and the corundum roller 120 may be mechanically coupled to each other by the motor 302 placed in the bottom 108 of the flour milling device 100A via a belt 304. The belt 304 may be connected to a rotor of the motor 302 and the pair of anodized aluminum rollers 114, 116, and the corundum roller 120, as depicted via the present FIG. 3. The belt 304 may be, but not limited to, a timing belt, a synchronous belt, a rubber belt, a serpentine belt, a fan belt, an alternator belt, and the like.

Once the grinding option is selected, and the spacing and speed is adjusted, the pair of anodized aluminum rollers 114, 116 may receive the grains from the narrow opening of the hopper 112. Further, the motor 302 may start rotating the pair of anodized aluminum rollers 114, 116 in the clockwise direction and the anticlockwise direction, respectively. It should be noted that the clockwise direction and the anticlockwise direction of rotation of the pair of anodized aluminum rollers 114, 116 respectively, may be applicable when looking from the back view of the flour milling device 100A. In some embodiment, while looking from a front view of the flour milling device 100A, a direction of rotation of the pair of anodized aluminum rollers 114, 116 may be vice versa. In other words, the first anodized aluminum roller 114 may rotate in the anticlockwise direction, while the second anodized aluminum roller 116 may rotate in the clockwise direction during the grains milling process. By way of an example, upon selecting the one-fourth broken grains option and after adjusting the spacing and the speed, the pair of anodized aluminum rollers 114, 116 may roll the grains when the grains are passed from in-between the first anodized aluminum roller 114 and the second anodized aluminum roller 116.

Further, the corundum stone 118 and the corundum roller 120 may receive rolled grains from the pair of anodized aluminum rollers 114, 116. The motor 302 may rotate the corundum roller 120 along with the pair of anodized aluminum rollers 114, 116 via the belt 304. It should be noted that the corundum roller 120 may rotate in same direction as of the first anodized aluminum roller 114. Further, the corundum stone 118 and the corundum roller 120 may break the rolled grains into the one-fourth broken grains as the rolled grains pass through the corundum stone 118 and the corundum roller 120.

Further, the one-fourth of broken grains may get collected in the removable collector vessel 110 after passing from the corundum stone 118 and the corundum roller 120. The removable collector vessel 110 may be manufactured of material, for example, a polyvinyl chloride (PVC), a rubber, an alloy, a metal, or any other similar material. As already explained above, the flour milling device 100A may recommend one or more grinding options, i.e., the rolled grains option, the half-broken grains option, the one-fourth broken grains option, the coarse powder option, and the fine powder option, to the user based on the type of grains identified. Further, based on the selected grinding option, the spacing and the speed of the pair of anodized aluminum rollers 114, 116, and the corundum stone 118 and the corundum roller 120 may be adjusted to grind (or mill) the grains in rolled grains, the half-broken grains, the one-fourth broken grains, coarse powder, and fine powder based on the selected grinding option.

In an exemplary embodiment, let's suppose a user fed the hopper 112 with whole wheat grains and the flour milling device 100A generates the rolled grains option, the half-broken grains option, the one-fourth broken grains option, the coarse powder option, and the fine powder option. The user selects the rolled grains option via the communication system 106. For this option, the spacing between the pair of anodized aluminum rollers 114, 116 is adjusted such that the pair of anodized aluminum rollers 114, 116 engages with each other at the spacing of 2.5 mm (i.e., a first pre-defined distance defined for the rolled grains option). Whereas the corundum stone 118 and the corundum roller 120 may disengage such that the spacing between them is 5 mm (a maximum second pre-defined distance defined for the rolled grains option). As will be appreciated, the corundum stone 118 and the corundum roller 120 may disengage from each other so for the rolled grains option, the corundum roller 120 does not rotate based on action of the motor 302, and the corundum roller 120 and the corundum stone 118 are at maximum distance from each other. In other words, for the rolled grains option, the pair of anodized aluminum rollers 114, 116 will be engaging to crush or squeeze incoming whole wheat grains and convert it to the rolled grains. In addition, the corundum stone 118 and the corundum roller 120 may be at farthest position, so that the rolled grains pass through them without any block and gets directly collected in the removable collector vessel 110.

In another exemplary embodiment, let's suppose the user may select the half-broken grains option for the whole wheat grains fed into the hopper 112. For this option, the flour milling device 100A may not adjust the spacing between the pair of anodized aluminum rollers 114, 116. In other words, the pair of anodized aluminum rollers 114, 116 may not be engaged and the spacing between them is, for example, 5 mm (a maximum first pre-defined distance defined for the half-broken grains option). However, the flour milling device 100A may adjust the spacing between the corundum stone 118 and the corundum roller 120 to engage the corundum stone 118 and the corundum roller 120 such that the spacing between them is, e.g., 2.5 mm (a second pre-defined distance defined for the half-broken grains option). In other words, for the half-broken grains option, the whole wheat grains may get crushed directly in the corundum stone 118 and the corundum roller 120 to get converted into the half-broken grain which is then collected in the removable collector vessel 110.

In another exemplary embodiment, let's suppose the user may select the one-fourth broken grains option for the whole wheat grains fed into the hopper 112. For this option, the flour milling device 100A may disengage the pair of anodized aluminum rollers 114, 116 to adjust the spacing such that the spacing between them is, e.g., 5 mm (i.e., the maximum pre-defined distance defined for the one-fourth broken grains option). Further, the flour milling device 100A may engage the corundum stone 118 and the corundum roller 120 by adjusting the spacing such that the spacing between them is, e.g., 2 mm (i.e., a second pre-defined distance defined for the one-fourth broken grains option). In this case, the whole wheat grains pass freely in between the pair of anodized aluminum rollers 114, 116 and get broken into one-fourth broken grains upon passing through the corundum stone 118 and the corundum roller 120, which is then collected in the removable collector vessel 110.

In another exemplary embodiment, let's suppose the user may select the coarse powder option for the whole wheat grains fed into the hopper 112. For this option, the flour milling device 100A may engage the pair of anodized aluminum rollers 114, 116 such that the spacing between them is, e.g., 1 mm (i.e., a first pre-defined distance defined for the coarse powder option) for rolling the whole wheat grains into the rolled grains. Further, the flour milling device 100A may engage the corundum stone 118 and the corundum roller 120 such that the spacing between them is, e.g., 1.5 mm (i.e., a second pre-defined distance defined for the coarse powder option) for breaking the rolled grains into coarse powder which is then collected into the removable collector vessel 110.

In another exemplary embodiment, let's suppose the user may select the fine powder option for the whole wheat grains fed into the hopper 112. For this option, the flour milling device 100A may engage the pair of anodized aluminum rollers 114, 116 such that the spacing between them is, e.g., 1 mm (i.e., a first pre-defined distance defined for the fine powder option) for rolling the whole wheat grains into the rolled grains. Further, the flour milling device 100A may engage the corundum stone 118 and the corundum roller 120 such that the spacing between them is, e.g., 0.5 mm (i.e., a second pre-defined distance defined for the fine powder option) for breaking the rolled grains into fine powder which is then collected into the removable collector vessel 110. It should be noted that, in addition to the adjustment of the spacing based on the selected grinding option of the at least one grinding option, the speed of each of the pair of anodized aluminum rollers 114, 116, and the corundum roller 120 may be automatically adjusted based on the selected grinding option of each of the at least one grinding option.

As will be appreciated by one skilled in the art, a variety of processes may be employed for milling grains through the flour milling device 100A. For example, the flour milling device 100A and associated components (e.g., the set of NIRED sensors and the communication system 106) may identify and mill the grains by the processes discussed herein. In particular, as will be appreciated by those of ordinary skill in the art, control logic and/or automated routines for performing the techniques and steps described herein may be implemented by the flour milling device 100A either by hardware, software, or combinations of hardware and software. For example, suitable code may be accessed and executed by the one or more processors on the flour milling device 100A to perform some or all of the techniques described herein. Similarly, application specific integrated circuits (ASICs) configured to perform some, or all of the processes described herein may be included in the one or more processors on the flour milling device 100A.

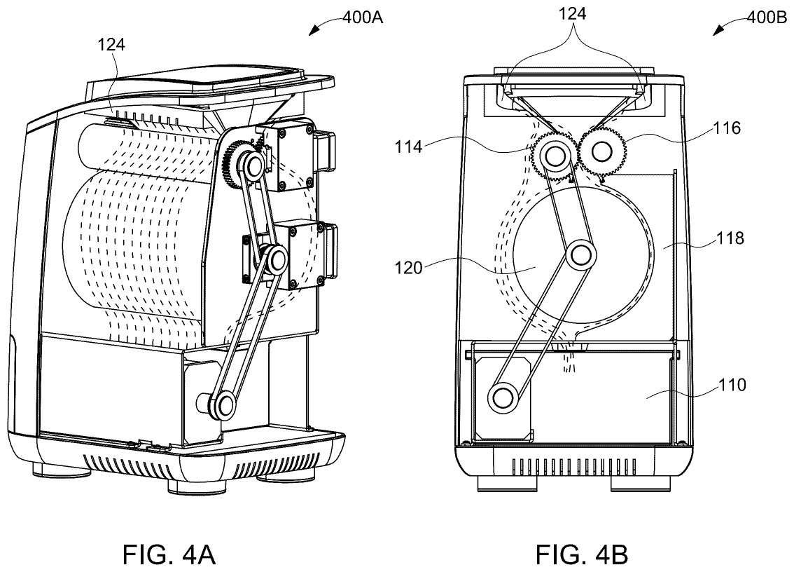

Referring now to FIGS. 4A and 4B, an exemplary inbuilt cleaning mechanism of the flour milling device 100A is represented, in accordance with some embodiments of the present disclosure. FIGS. 4A and 4B are explained in conjunction with FIGS. 1A-3. With reference to FIG. 1C, the inbuilt cleaning mechanism of the flour milling device 100A may be configured to automatically clean the flour milling device 100A. The inbuilt cleaning mechanism may include the set of steel brushes and the pair of blowers 124. It should be noted that each of the pair of blowers 124 may include the set of fans.

In an embodiment, a brush of the set of steel brushes may be positioned in contact with a circumference of each of the first anodized aluminum roller 114, the second anodized aluminum roller 116, and the corundum roller 120. For example, suppose the set of steel brushes may include three steel brushes. Further, the first steel brush 126A and the second steel brush 126B of the set of steel brushes may be positioned in contact with the circumference of the first anodized aluminum roller 114 and the second anodized aluminum roller 116, respectively. Further, the third steel brush 126C may be positioned in contact with the circumference of the corundum roller 120. Further, the pair of blowers 124 may be positioned below the hopper 112 and in-line with the first anodized aluminum roller 114, the second anodized aluminum roller 116, and the corundum roller 120. In simpler words, the set of steel brushes may scratch the circumference of each of the first anodized aluminum roller 114, the second anodized aluminum roller 116, and the corundum roller 120 to scrap any remains of the milled grains that may be stuck on their surface.

Further, at same time, the pair of blowers 124 may be configured to blow the remains of the milled grains into the removable collector vessel 110. To blow the remains, the set of fans of each of the pair of blowers 124 may blow air, such that the air may pass through the pair of anodized aluminum rollers 114, 116, and the corundum stone 118 and the corundum roller 120 to collect the remains into the removable collector vessel 110. The pair of blowers 124 may be placed below the hopper 112 and above the pair of anodized aluminum rollers 114, 116. Further, the pair of blowers 124 may blow air in-between and around the pair of anodized aluminum rollers 114, 116 for thorough cleaning of the pair of anodized aluminum rollers 114, 116. Further, the pair of blowers 124 may blow air in-between and around the corundum stone 118 and the corundum roller 120 for thorough cleaning. An exemplary depiction of the air flowing through the pair of anodized aluminum rollers 114, 116, and the corundum roller 120 and the corundum stone 118 is depicted via a first cross-sectional view 400A and a second cross sectional view 400B of FIGS. 4A and 4B respectively.

With reference to FIG. 2, the inbuilt cleaning mechanism may be initiated upon receiving a user selection for initiation the cleaning process for the flour milling device 100A. In one embodiment, the user selection may be received from the user as a user input via the communication system 106 of the flour milling device 100A. In another embodiment, the user selection to initiate the cleaning process may be received from the user via the milling application installed in the user device.

Referring now to FIG. 5, a pictorial depiction of an exemplary process 500 of operating the flour milling device 100A is illustrated, in accordance with some embodiments of the present disclosure. FIG. 5 is explained in conjunction with FIGS. 1A-4. Consider a scenario where a user wants to grind the wheat grains to the fine powder using the flour milling device 100A for making chapati's, i.e., Indian bread. In this scenario, as depicted via step 502, initially, the user may remove the lid 104 to feed the wheat grains into the hopper 112 of the flour milling device 100A. Further, upon feeding the wheat grains to the hopper 112, the user may cover the hopper 112 with the lid 104. The user may place the lid 104 back to make sure that no dust particles or other impurities enter the hopper 112 during the grain milling process. Moreover, the lid 104 may be placed back to avoid spilling of the wheat grains during the grain milling process.

Once the wheat grains are fed into the hopper 112 and the lid 104 is placed back, the user may start the grains milling process either immediately or after some based on his requirement. In one embodiment, when the user wants to grind the wheat grains immediately upon feeding the wheat grains to the hopper 112, in this case, the user may press the power button 204 as depicted via step 504. Upon starting the grains milling process, the set of NIRED sensors integrated within the hopper 112 may identify the type of grains (in this case the wheat grains) fed into the hopper 112. Further, based on the identification of the type of grains, the flour milling device 100A may generate at least one grinding option that is rendered as the recommendation to the user. For example, the at least one grinding option rendered to the user may include the rolled grains option, the half-broken grains option, the one-fourth broken grains option, the coarse powder option, and the fine powder option. In this embodiment, the at least one grinding option may be rendered to the user via the interactive display 202 of the communication system 106 of the flour milling device 100A.

By way of an example, suppose the user may select the fine powder option from the at least one grinding option rendered to him using the pair of navigation buttons 210 and the select button 208. This has been already depicted and explained in detail in FIG. 2. Upon receiving the fine powder option as an input, the flour milling device 100A may start the grains milling process to grind the wheat grains into the fine powder. In another embodiment, when the user wants to grind the wheat grains after sometime, once the wheat grains are fed to the hopper 112 and the user is not physically present around the flour milling device 100A, then the user may operate the flour milling device 100A via the milling application installed within the user device to start the grains milling process. The user device may be communicatively coupled with the flour milling device 100A as already explained above in detail in FIG. 1A.

As will be appreciated, once the grains milling process is completed, a message including the notification of completion of the grains milling process may be displayed to the user. In an embodiment, the notification may be displayed to the user via the interactive display 202 or the display of the user device. In some embodiments, the notification may be a musical alarm generated and played to alert the user about the completion of the grains milling process. Further, upon receiving the message for the completion of the grain milling process, at step 506, the user may collect the fine powder of the wheat grains from the removable collector vessel 110 using a handle. To collect the fine powder of the wheat grains, the user may completely detached the removable collector vessel 110 from the flour milling device 100A to transfer the fine powder to the container for usage as depicted via step 508. Further, upon collecting the fine powder, at step 510, the user may enable the inbuilt cleaning mechanism to start the cleaning process of the flour milling device 100A via the communication system 106 or the milling application. The inbuilt cleaning mechanism has been already depicted and explained in detail in conjunction with FIGS. 4A and 4B.

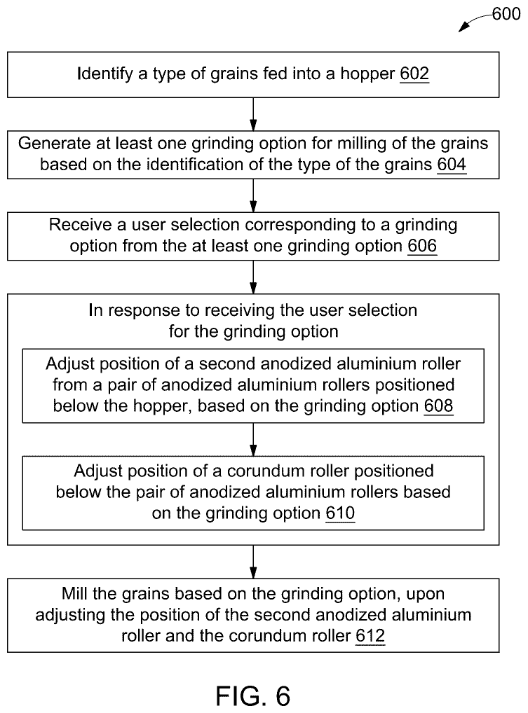

Referring now to FIG. 6, a method 600 of milling grains through the flour milling device 100A is depicted via a flowchart, in accordance with some embodiments of the present disclosure. FIG. 6 is explained in conjunction with FIGS. 1A-5. Initially, at step 602, a type of grains fed into a hopper (i.e., the hopper 112) may be identified via a set of NIRED sensors. The set of NIRED sensors may be integrated within the hopper 112. It should be noted that the grains may be filled in the hopper 112 by the user.

Upon identifying the type of grains, at step 604, at least one grinding option may be generated for milling of the grains. The at least one grinding option may be generated based on the identification of the type of the grains. Examples of the at least one grinding option may include, but is not limited to, a rolled grains option, a half-broken grains option, a one-fourth broken grains option, a coarse powder option, and a fine powder option. As will be appreciated, the at least one grinding option may be rendered to the user via the interactive display 202 of the communication system 106. It should be noted that, in addition to the at least one grinding option, the interactive display 202 may be configured to display a grain volume option, a progress in the grains milling process, a notification of completion of the grains milling process, and a notification of completion of cleaning process to the user.

Further, at step 606, a user selection corresponding to a grinding option from the at least one grinding option may be received. By way of an example, suppose the type of grains that are fed into the hopper 112 includes chickpeas lentils. In this case upon identifying the type of the grains using the set of NIRED sensors, the at least one grinding option that is generated and rendered to the user may include the coarse powder option and the fine powder option. Further, from the coarse powder option and the fine powder option, the user may have selected the coarse powder option based on his requirements. It should be noted that, in addition to the one grinding option, the user may select the grain volume option as well using the communication system 106.

In response to receiving the user selection for the grinding option, at step 608, the flour milling device 100A may adjust a position of the second anodized aluminum roller 116 from the pair of anodized aluminum rollers 114, 116 positioned below the hopper 112 based on the grinding option. In continuation to the above example, based on the coarse powder option received as the user selection, the flour milling device 100A may adjust the position of the second anodized aluminum 116. In some embodiments, the position of the second anodized aluminum roller 116 may be adjusted based on the set of actuators, upon receiving the user selection for the grinding option. To adjust the position of the second anodized aluminum roller 116, the second anodized aluminum roller 116 may be moved via the set of actuators for a first pre-defined distance in a horizontal direction to automatically adjust a spacing between the first anodized aluminum roller 114 and the second anodized aluminum roller 116. As explained in above FIGS. 1C and FIG. 3, the first anodized aluminum roller 114 may be configured to remain stationary. In other words, the first anodized aluminum roller 114 may not be moved to adjust the spacing and is configured to rotate at its place based on the selected grinding option. Whereas the second anodized aluminum roller 116 may move in the horizontal direction to adjust the spacing based on the selected grinding option and rotate once the spacing is adjusted.

Further, in response to receiving the user selection for the grinding option, at step 610, the flour milling device 100A may adjust a position of the corundum roller 120 positioned below the pair of anodized aluminum rollers 114, 116 adjusted based on the grinding option. In continuation to the above example, based on the coarse powder option received as the user selection, the flour milling device 100A may adjust the position of the corundum roller 120. In some embodiments, the position of the corundum roller 120 may be adjusted via the set of actuators, upon receiving the user selection for the grinding option from the user. To adjust the position of the corundum roller 120, the corundum roller 120 may be configured to move for a second pre-defined distance in a horizontal direction via the set of actuators to automatically adjust a spacing between the corundum stone 118 and the corundum roller 120. As explained in above FIG. 1C and FIG. 3, the corundum stone 118 may be configured to remain stationary. In other words, the corundum stone 118 may not be moved to adjust the spacing. Whereas the corundum roller 120 may move in the horizontal direction to adjust the spacing based on the selected grinding option and rotate once the spacing is adjusted. In addition to the adjustment of the position of the second anodized aluminum roller 116 and the corundum roller 120, speed of the each of the pair of anodized aluminum rollers 114, 116, and the corundum roller 120 may be automatically adjusted based on the grinding option selected corresponding to the grains. Once the position and the speed are adjusted based on the grinding option, then at step 612, the flour milling device 100A may start milling of the grains based on the grinding option. Further, the milled grains may be collected in the removable collector vessel 110 placed at the bottom 108 of the flour milling device 100A. Once the milled grains are collected, the user may transfer the milled grains to a container by detaching the removable collector vessel 110 from the flour milling device 100A.

Further, once the grains milling process is over and the milled grains are transferred, then after attaching the removable collector vessel 110 back to its place in the flour milling device 100A, the user may activate an inbuilt cleaning mechanism by selecting a corresponding cleaning option to start cleaning process for the flour milling device 100A. As already explained in FIGS. 1A-4, the inbuilt cleaning mechanism may include a set of steel brushes (i.e., the first steel brush 126A, the second steel brush 126B, and the third steel brush 126C) and a pair of blowers. (i.e., the pair of blowers 124) The pair of blowers 124 may include a set of fans. The set of steel brushes and the pair of blowers 124 may be configured to automatically clean the pair of anodized aluminum rollers 114, 116, and the corundum stone 118 and the corundum roller 120.

By way of an example, upon starting the cleaning process, the pair of anodized aluminum rollers 114, 116, and the corundum roller 120 may start rotating and the set of steel brushes may scarp any remains of the milled grains from surface of the pair of anodized aluminum rollers 114, 116, and the corundum roller 120. Further, at the same time, the set of fans within each of the pair of blowers may blow air to move the remains from the surface of pair of anodized aluminum rollers 114, 116, and the corundum roller 120 and collect the remains into the removable collector vessel 110. Once the cleaning process is completed, the flour milling device 100A may notify the user by sending the notification for completion of the cleaning process. The user may then remove and clean or wash away the remains collected within the removable collected vessel 110, to clean the removable collected vessel 110 for next use.

As will also be appreciated, some of the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

Various embodiments provide a flour milling device. The disclosed device may include a hopper including a set of Near Infrared (NIRED) sensors configured for identifying a type of grains fed into the hopper to provide at least one grinding option as a recommendation to a user. Further, the disclosed flour milling device may include a pair of anodized aluminum rollers positioned below the hopper and horizontally aligned with each other. A first anodized aluminum roller may be stationary, and a second anodized aluminum roller is configured to move for a first pre-defined distance in a horizontal direction to automatically adjust a spacing between the first anodized aluminum roller and the second anodized aluminum roller based on a grinding option selected from the at least one grinding option. Further, the disclosed flour milling device may include a corundum stone and a corundum roller positioned below the pair of anodized aluminum rollers and are horizontally aligned with each other. The corundum stone may be stationary, and the corundum roller is configured to move for a second pre-defined distance in a horizontal direction to automatically adjust a spacing between the corundum stone and the corundum roller based on the grinding option. Furthermore, the disclosed flour milling device may include an inbuilt cleaning mechanism. The inbuilt cleaning mechanism may include a set of steel brushes and a pair of blowers configured to automatically clean the flour milling device. Further, each of the pair of blowers includes a set of fans.

Thus, the present disclosure may overcome drawbacks of traditional conventional products required for milling grains efficiently in a home environment. The present disclosure discloses a flour milling device that may provide freshly milled flour with rich flavors and nutrition, with options for customization and convenience without compromising the user's valuable time, energy, and effort making itself a more sustainable option. The disclosed flour milling device may offer compact design that requires less storage space hence saves a lot of space in a kitchen. The disclosed flour milling device may operate autonomously, requiring minimal user interaction. The user of the flour milling device may be able to easily set their desired milling preferences through intuitive controls. The disclosed flour milling device may use cutting-edge milling technology that minimizes heat dissipation during the grains milling process, ensuring that the nutritional content of the grains remains intact so that the user can enjoy the full benefits of fresh, rich in flavors nutrient-rich flour in their everyday cooking.

The disclosed flour milling device also values user's time as it is engineered in a way that provides a fine powder to the user in a single pass with the help of robust motor and precision milling mechanism that uses a combination of the pair of anodized aluminum rollers and the corundum stone and the corundum roller. The motor and the precision milling mechanism enables the disclosed flour milling device to deliver quick and effective results, thereby eliminating the need for multiple feedings. The disclosed flour milling device may provide a hassle-free milling experience to the user as compared to complicated process in currently existing milling machines. In other words, the user may be able to easily operate the disclosed flour milling device with the help of the communication system that is inbuilt or via the milling application even if the user is new to home milling device. Further, the disclosed flour milling device provides an inbuilt cleaning mechanism that may enable the user to automatically clean the flour milling device quickly and easily after the grains milling process. The cleaning process for the disclosed flour milling device may be initiated simply by selecting the corresponding cleaning option using the communication system or via the milling application. This process of quickly initiating the cleaning process with a single click eliminating the need of tedious and time-consuming manual cleaning process that the user has to perform post usage. This automated cleaning process provides a hygienic milling experience to the user during each use.

In light of the above-mentioned advantages and the technical advancements provided by the disclosed method and device, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described a flour milling device and method of milling grains through the flour milling device. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, non-volatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

I/We claim:

1. A flour milling device comprising:
a hopper comprising a set of Near Infrared (NIRED) sensors configured for identifying a type of grains fed into the hopper to provide at least one grinding option as a recommendation to a user;
a pair of anodized aluminum rollers positioned below the hopper and are horizontally aligned with each other, wherein a first anodized aluminum roller is stationary, and a second anodized aluminum roller is configured to move for a first pre-defined distance in a horizontal direction to automatically adjust a spacing between the first anodized aluminum roller and the second anodized aluminum roller based on a grinding option selected from the at least one grinding option;
a corundum stone and a corundum roller positioned below the pair of anodized aluminum rollers and are horizontally aligned with each other, wherein the corundum stone is stationary, and the corundum roller is configured to move for a second pre-defined distance in a horizontal direction to automatically adjust a spacing between the corundum stone and the corundum roller based on the grinding option; and
an inbuilt cleaning mechanism comprising a set of steel brushes and a pair of blowers configured to automatically clean the flour milling device, wherein each of the pair of blowers comprises a set of fans.

2. The flour milling device of claim 1, further comprising a lid present on top of the flour milling device to access the hopper for adding the grains to the hopper.

3. The flour milling device of claim 1, further comprising a communication system, wherein the communication system comprising:
an interactive display configured to display messages to the user, wherein the messages include the at least one grinding option, a grain volume option, a progress in grains milling process, a notification of completion of the grains milling process, and a notification of completion of cleaning process;
a set of buttons for operating the flour milling device, selecting the grinding option, and starting the cleaning process; and
a communication module for sending the messages to a user device and receiving commands from the user corresponding to the selected grinding size option, starting the grains milling process, and starting the cleaning process, via the user device.

4. The flour milling device of claim 1, wherein the at least one grinding option comprises a rolled grains option, a half-broken grains option, a one-fourth broken grains option, a coarse powder option, and a fine powder option.

5. The flour milling device of claim 1, further comprising a set of actuators configured to move the second anodized aluminum roller for the first pre-defined distance, and to move the corundum roller for the second pre-defined distance, to adjust the spacing.

6. The flour milling device of claim 1, wherein speed of each of the pair of anodized aluminum rollers, and the corundum roller is automatically adjusted based on the grinding option selected corresponding to the grains.

7. The flour milling device of claim 3, further comprising a removable collector vessel placed at a bottom for collecting milled grains during the grains milling process.

8. The flour milling device of claim 7, wherein the bottom further comprises:
a motor to operate the flour milling device; and
a set of shock absorbent bushes to stabilize movement of the flour milling device.

9. The flour milling device of claim 1, wherein a brush of the set of steel brushes is positioned in contact with a circumference of each of the first anodized aluminum roller, the second anodized aluminum roller, and the corundum roller, and wherein the pair of blowers is positioned below the hopper and in-line with the first anodized aluminum roller, the second anodized aluminum roller, and the corundum roller.

10. A method for milling grains through a flour milling device, the method comprising:
identifying, by the flour milling device via a set of Near-Infrared (NIRED) sensors, a type of grains fed into a hopper, wherein the hopper comprises the set of NIRED sensors;
generating, by the flour milling device, at least one grinding option for milling of the grains based on the identification of the type of the grains;
receiving, by the flour milling device, a user selection corresponding to a grinding option from the at least one grinding option;
in response to receiving the user selection for the grinding option,
adjusting, by the flour milling device, position of a second anodized aluminum roller from a pair of anodized aluminum rollers positioned below the hopper, based on the grinding option; and
adjusting, by the flour milling device, position of a corundum roller positioned below the pair of anodized aluminum rollers based on the grinding option; and
milling, by the flour milling device, the grains based on the grinding option, upon adjusting the position of the second anodized aluminum roller and the corundum roller.

11. The method of claim 10, wherein the at least one grinding option comprises a rolled grains option, a half-broken grains option, a one-fourth broken grains option, a coarse powder option, and a fine powder option.

12. The method of claim 10, further comprising:
collecting the milled grains in a removable collector vessel placed at a bottom of the flour milling device.

13. The method of claim 10, wherein adjusting the position of the of the second anodized aluminum roller comprises:
moving, via a set of actuators, the second anodized aluminum roller for a first pre-defined distance in a horizontal direction to automatically adjust a spacing between a first anodized aluminum roller and the second anodized aluminum roller, wherein the first anodized aluminum roller of the pair of anodized aluminum is stationary.

14. The method of claim 10, wherein adjusting the position of the corundum roller comprises:
moving, via the set of actuators, the corundum roller for a second pre-defined distance in a horizontal direction to automatically adjust a spacing between a corundum stone and the corundum roller, wherein the corundum stone is stationary.

15. The method of claim 10, further comprising:
receiving a user selection for cleaning the flour milling device, upon completion of grains milling process; and
activating an inbuilt cleaning mechanism to start cleaning process of the flour milling device in response to receiving the user selection for cleaning.

16. The method of claim 15, wherein the inbuilt cleaning mechanism comprises a set of steel brushes and a pair of blowers configured to automatically clean the pair of anodized aluminum rollers, and the corundum roller and the corundum stone, wherein each of the pair of blowers comprises a set of fans.

17. The method of claim 10, further comprising:
rendering, via an interactive display, the at least one grinding option, a grain volume option, a progress in the grains milling process, a notification of completion of the grains milling process, and a notification of completion of cleaning process, to a user.
